(19) United States
(12) Patent Application Publication
(10) Pub. No.: US 2026/0235808 A1
(43) Pub. Date: Aug. 13, 2026

(54) PHOTONIC WIRE BOND STRUCTURES TO FACILITATE OPTICAL COUPLING WITH A 2-D ARRAY OF MULTI-CORE FIBERS

(71) Applicant: Intel Corporation, Santa Clara, CA (US)

(72) Inventors: Feifei Cheng, Chandler, AZ (US); Dekang Chen, Chandler, AZ (US); Fan Fan, Chandler, AZ (US); Zhichao Zhang, Chandler, AZ (US); Saikumar Jayaraman, Chandler, AZ (US); Kumar Abhishek Singh, Phoenix, AZ (US)

(73) Assignee: Intel Corporation, Santa Clara, CA (US)

(21) Appl. No.: 18/620,766

(22) Filed: Mar. 28, 2024

(51) Int. Cl. G02B 6/122; G02B 6/13

(52) U.S. Cl. CPC G02B 6/1228; G02B 6/13

(57) ABSTRACT

Techniques and mechanisms for optically coupling photonic wire bond (PWB) structures each to a respective optical fiber core of a plurality of multi-core fibers. In one embodiment, multiple PWBs are fabricated by a three-dimensional (3D) printing process which facilitates efficient alignment of the multiple PWBs with a fiber array unit or other device which comprises, or accommodates coupling to, the plurality of multi-core fibers. Such efficient alignment enables the multi-core fibers to be arranged in a two-dimensional (2D) array. In other embodiments, the 3D printing process comprises a two-photon polymerization process.

### STATEMENT OF GOVERNMENT INTEREST

This Invention was made with Government support under Agreement No. N00164-19-9-0001, awarded by NSWC Crane Division. The Government has certain rights in the Invention.

### BACKGROUND

### 1. Technical Field

This disclosure generally relates to optical interconnect structures and more particularly, but not exclusively, to optical coupling of photonic wire bond structures to multi-core fibers.

### 2. Background Art

The continued growth of the digital economy, and its associated intra-datacenter traffic, requires datacenter systems to utilize interconnect technologies which provide higher bandwidths and power efficiency. Silicon photonic input/output (I/O) technologies have the advantages of relatively low loss, compact size, low power, high-bandwidth interconnect capabilities. Co-packaged optics (CPO) heterogeneously integrate photonics devices into packaged components, such as chip, interposer, coupler, etc. for wide range of applications in datacenter networking, AI/high performance computing, disaggregated system, etc. However, scalability of photonics co-packaging and system assembly still presents major challenges. Specifically, due to high requirement on alignment precision, chip-to-chip and chip-to-fiber coupling are often rely on active alignment processes, which tend to lead to low throughput and high cost.

### BRIEF DESCRIPTION OF THE DRAWINGS

The various embodiments of the present invention are illustrated by way of example, and not by way of limitation, in the figures of the accompanying drawings and in which:

FIG. 1 shows a flow diagram illustrating features of a method to provide optical coupling with photonic wire bond structures according to an embodiment.

FIGS. 2A, 2B show various views illustrating features of a system to provide optical coupling with photonic wire bond structures according to an embodiment.

FIG. 2C shows a side view of a photonic wire bond structure to provide optical coupling according to an embodiment.

FIG. 3 shows an end view of optical interface surfaces which are arranged in a two-dimensional array for optically coupling with photonic wire bond structures according to an embodiment.

FIG. 4 shows a side view diagram illustrating features of a system comprising photonic wire bond structures which facilitate use of an optical connector device according to an embodiment.

FIG. 5 shows a side view diagram illustrating features of a system comprising photonic wire bond structures which variously form routes for optical coupling of micro-lenses with a PIC according to an embodiment.

FIG. 6 shows a side view diagram illustrating features of a system comprising photonic wire bond structures which are optically coupled each to a respective end of a waveguide according to an embodiment.

FIG. 7 illustrates a mobile computing platform and a data server machine comprising optical interconnect structures, in accordance with some embodiments; and

FIG. 8 is a functional block diagram of an electronic computing device, that may implement one or more of the components of the mobile platform or data serve machine illustrated in FIG. 7, in accordance with some embodiments.

### DETAILED DESCRIPTION

Embodiments discussed herein variously provide techniques and mechanisms for optically coupling photonic wire bond (PWB) structures each to a respective optical fiber core of a plurality of multi-core fibers. In one embodiment, multiple PWBs are fabricated by a three-dimensional (3D) printing process which facilitates efficient alignment and/or other positioning of the multiple PWBs with respect to one or more devices such as a fiber array unit (FAU), a photonic integrated circuit (PIC), and/or the like. In various embodiments, the multi-core fibers are arranged in a two-dimensional (2D) array.

Some embodiments variously comprise performing a 3D printing of PWBs to facilitate the provisioning of an optical co-packaging coupling interface. As compared to existing solutions, such embodiments variously mitigate alignment constraints and/or enable increased PIC shoreline I/O density. These advantages improve the scalability of optical packaging solutions.

Reference is made in the following detailed description to the accompanying drawings, which form a part hereof and illustrate exemplary embodiments. Further, it is understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause-and-effect relationship).

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including an optical interface including multiple PWBs which are coupled to (and/or which accommodate coupling to) an array of multi-core fibers.

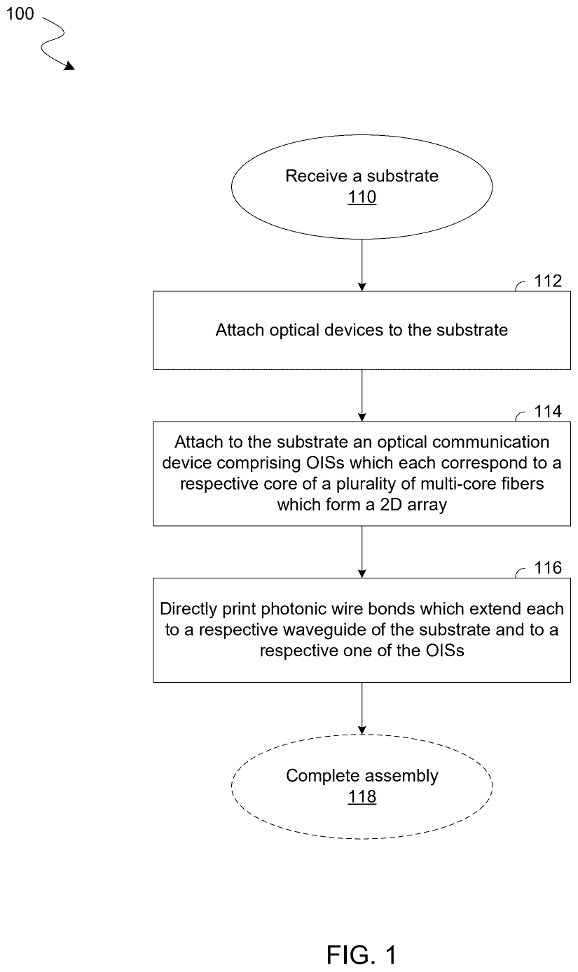

FIG. 1 shows methods 100 for providing optical coupling with photonic wire bond structures (“photonic wire bonds” or “PWBs” herein) according to an embodiment. The methods 100 illustrate one example of an embodiment wherein PWBs are optically coupled-directly or indirectly—each to a respective core of a plurality of multi-core fibers. In an embodiment, the plurality of multi-core fibers is arranged to form a 2D array.

As shown in FIG. 1, methods 100 begin at input 110 where a workpiece comprising a suitable substrate is received as an input. In some examples, methods 100 are practiced on a workpiece comprising a PIC chip. The PIC chip may be the substrate, or the PIC chip may have been previously assembled upon a package substrate that is received at input 110. In other embodiments, a PIC chip has not yet been assembled to the package substrate received at input 110 and methods 100 may be completed prior to further assembling a PIC chip to the package substrate. In some embodiments, methods 100 are practiced upon in a single (e.g., first) substrate. However, in some alternative implementations, some blocks of methods 100 may be practiced on a first substrate while other blocks are practiced on a second substrate. The multiple substrates may then be assembled with another (third) substrate and a remainder of the blocks of methods 100 completed.

At block 112, a plurality of optical devices is attached to a substrate. Each optical device may be any optical device suitable for coupling with an optical fiber. In exemplary embodiments, the optical devices attached at block 112 include one or more of an optical emitter or an optical (photo)detector. However, other optical devices, such as array waveguide gratings (AWG), optical modulators, or the like, may be similarly attached to a substrate at block 112. Any means of attachment known to be suitable for a particular optical device and substrate combination may be practiced at block 112 as embodiments are unlimited in this respect. In some examples, semiconductor light emitters and/or semiconductor photodetectors are attached with surface mount technology.

Methods 100 continue at block 114 where an optical communication device is attached to the substrate. The optical communication device comprises multiple optical interface surfaces (OISs) which each correspond to a respective core of a plurality of multi-core fibers. In this particular context, the term “optical interface surface” refers herein to a surface structure of an optically transmissive body (such as that of a fiberoptic core, a micro-lens, a photonic wire bond, a waveguide, or the like), wherein the surface structure accommodates communication of an optical signal between the optically transmissive body and some other optically transmissive body.

In some embodiments, the optical communication device comprises the plurality of multi-core fibers-e.g., wherein the optical communication device comprises a fiber array unit (FAU). In one such embodiment, the multiple OISs are each formed by an end of a respective core of the plurality of multi-core fibers. In another embodiment, the optical communication device accommodates coupling to another optical communication device which includes the plurality of multi-core fibers. By way of illustration and not limitation, the optical communication device is any of various suitable connector devices-such as an expanded beam connector (EBC), for example-which facilitates (re)connection with a FAU or other such device. In one such embodiment, OISs are variously formed each by an end of a respective waveguide (or, for example, by a respective micro-lens) of such a connector device.

In an embodiment, cores of the plurality of multi-core fibers are any of various types which are suitable for communication with the optical devices attached at block 112. In some examples, the cores comprise one or more multi-mode (MM) fiber cores each having any of various suitable compositions (e.g., a glass media). In an embodiment, the optical communication device is affixed directly or indirectly to the substrate-e.g., with any techniques and/or structures known to be suitable for the multi-core fibers and the substrate combination, as embodiments are unlimited in this respect. No order is implied by the numbering of blocks 112 and 114 as optical fibers and optical devices may be attached according to any sequence.

In an embodiment, the multi-core fibers form a two-dimensional (2D) array—e.g., wherein respective ends of the multi-core fibers are arranged each to be in a respective one of multiple columns and a respective one of multiple rows. In one such embodiment, the 2D array includes a rectilinear array of some or all multi-core fibers or (alternatively) a non-rectilinear array of some or all multi-core fibers. By way of illustration and not limitation, each of the multi-core fibers forms a different respective group of OISs (or “OIS group” herein), each comprising only a respective subset of the multiple OISs. For example, the 2D array comprises an M×N array of such OIS groups (wherein M, and N are respective integers each greater than one). In various embodiments, multiple OIS groups each correspond to (for example, are formed by) a different respective one of the multi-core fibers, wherein some or all of the multiple OIS groups are substantially congruent with each other—e.g., wherein two or more of the OIS groups each have substantially the same arrangement of respective cores relative to each other. In one such embodiment, an arrangement of neighboring OISs which span a given two of these OIS groups is substantially incongruent with the arrangement of OISs in one of these OIS groups. In one example embodiment, a first OIS group is substantially incongruent with a second OIS group where a ratio of two distances—each distance between a different respective pair of OISs of the first OIS group—is different, by at least five percent (and, for example, by at least ten percent), from another ratio of corresponding distances for the second OIS group.

Methods 100 continue at block 116 where photonic wire bonds (PWBs) are directly printing each to extend to a respective waveguide of the substrate, and further to a respective one of the OISs. In contrast to a planar, slab, rib, ridge, or channel optical waveguide, which all comprise some planar portion of substrate material, a PWB comprises a non-planar optical waveguide structure which vertically spans a distance above, or “off” of an underlying substrate. As a non-planar waveguide, a PWB may be freely suspended above the substrate. In contrast to an optical fiber waveguide drawn from glass, a PWB is advantageously printed with a material other than glass (such as a polymer), in some embodiments. Similar to an electrical bond wire, a PWB in accordance with embodiments herein is a point-to-point optical interconnect.

PWB printing may progress by building up the wire material either from a surface of the substrate or from a surface of an OIS. Wire printing may proceed by controlling a free-space translation of a printhead that comprises a micropipette through which a polymer precursor solution is transported and/or extruded to form a meniscus where solvent from the polymer precursor solution is evaporated at a rate controlled to match translation of the printhead. With evaporation of the solvent, dissolved polymer precursor material solidifies (e.g., crosslinks) to form a solid polymer material (e.g., having a circular cross-sectional shape).

In some embodiments, the printing at 116 comprises performing two-photon polymerization (2PP) to form the PWBs. In various embodiments, 2PP processing comprises directing a laser light to trigger a reaction which forms a polymer from one or more light-sensitive target materials (e.g., including any of various suitable resin molecules). As compared to stereolithography (for example), 2PP substantially limits polymerization to a small region in which photon density is high enough to enable a target molecule to simultaneously absorb two photons of laser light. Such a region is provided, for example, with a tight focusing of a laser beam and/or an ultrashort pulsation of said laser beam (for example)

After such 2PP is completed, the resulting 3D printed PWB structures are cleaned, with any of various suitable solvents, to remove unexposed liquid portions of the target material(s). Since it presents relatively few design restrictions, 2PP enables a more efficient and precise fabrication of PWB structures-e.g., on smaller scales and/or wider ranges of scales (e.g., in a range of 100 nm to multiple centimeters). In some embodiments, after the printing at 116, methods 100 are complete at output 118 where a photonic device assembly is completed, for example according to any known techniques.

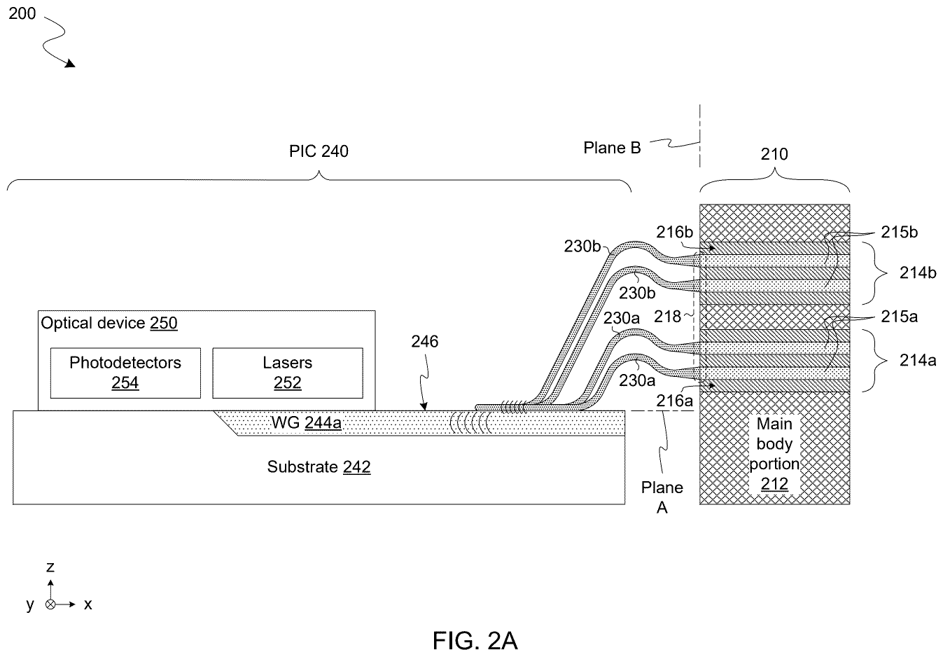

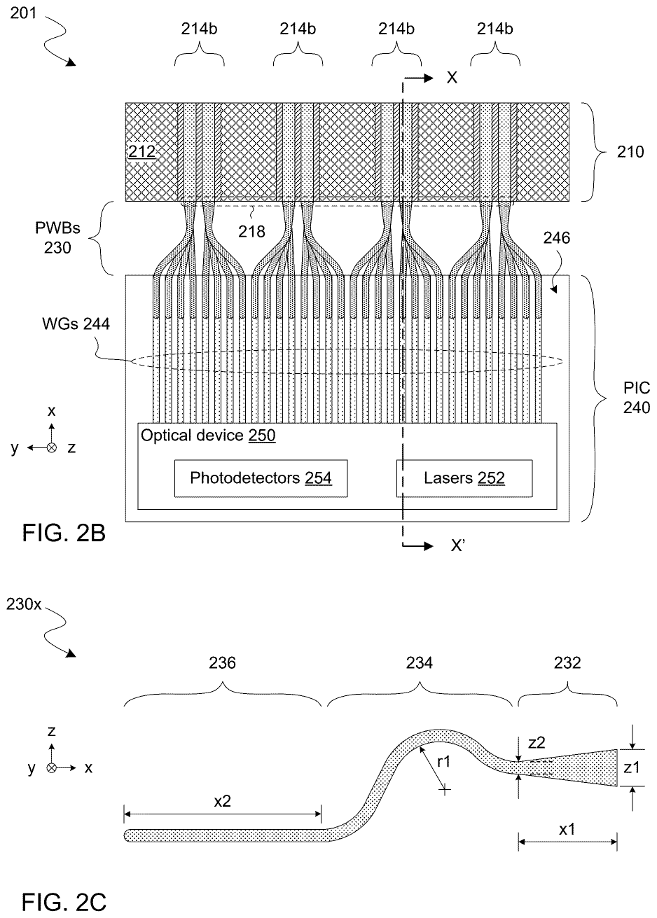

FIGS. 2A, 2B show a cross-sectional side view and a cross-sectional top view, respectively, of a system 200 to provide optical coupling with photonic wire bonds (PWBs) according to an embodiment. The side view shown in FIG. 2A corresponds to the cross-section which is indicated by the line X-X′ in the top view 201 shown in FIG. 2B. Structures are variously shown in FIGS. 2A-2C, and 3-5 with reference to an xyz Cartesian coordinate system. Unless otherwise indicated, “length” refers herein to a dimension along the x-axis of the coordinate system, wherein “width” and “height” refer to dimension along the y-axis and the z-axis (respectively) of the coordinate system.

System 200 illustrates features of one example embodiment wherein PWBs have been fabricated-e.g., by any of various suitable 3D print techniques-to accommodate optical coupling between a two-dimensional (2D) array of multi-core fibers and (for example) a photonic integrated circuit (PIC). In some embodiments, one or more operations of methods 100 are performed with, or provide structures of, system 200. However, some or all structures of system 200 may also be fabricated according to alternative methods, in other embodiments.

As shown in FIG. 2A, system 200 comprises a photonic integrated circuit (PIC) 240, an optical communication device 210, and multiple photonic wire bonds (PWBs)—referred to herein collectively as PWBs 230 (and individually each as a PWB 230)—which are each optically coupled between PIC 240 and optical communication device 210. In an embodiment, optical communication device 210 comprises a fiber array unit, and/or any of various other suitable devices, which comprise a plurality of multi-core fibers. PIC 240 comprises waveguides which variously accommodate optical communication with the multi-core fibers via the PWBs 230.

In the example embodiment shown, PIC 240 comprises a substrate 242 in which, or on which, is formed multiple optical waveguides (WGs) 244, including the illustrative waveguide (WG) 244a shown. One or more optical devices (e.g., comprising the illustrative optical device 250 shown) are attached to a top surface 246 of substrate 242. The one or more optical devices each comprise a respective one or more components—e.g., including one or more emitters and/or one or more detectors—which are variously coupled each to communicate a respective optical signal via a corresponding one of WGs 244.

In one such embodiment, top surface 246 is substantially planar and, for example, extends in the illustrative horizontal (x-y) plane A which is shown. Substrate 242 is any of various substrate structures which are suitable for physical assembly of multiple optical data links. In exemplary embodiments, substrate 242 is a PIC package substrate which, for example, includes one or more materials such as an epoxy preform, cored or coreless laminate board, a substantially homogenous bulk glass, or a monocrystalline silicon substrate. In some embodiments, substrate 242 includes one or more metallized redistribution levels (not depicted) which are embedded within a dielectric material. Alternatively or in addition, substrate 242 includes one or more IC die (not depicted) embedded therein. In some exemplary embodiments, substrate 242 accommodates coupling to a printed circuit board (not depicted) comprising a composite such as FR4.

In various embodiments, optical device 250 includes multiple optical emitters and/or multiple optical detectors (e.g., such as the illustrative lasers 252 and photodetectors 254 shown) which, for example, are each attached to substrate 242 according to any of various suitable techniques. In some examples, some or all of lasers 252 and/or some or all of photodetectors 254 are surface mounted, for example with solder interconnects. Alternatively or in addition, some or all of lasers 252 and/or some or all of photodetectors 254 are directly bonded to substrate 242, or are monolithically integrated into substrate 242.

Optical device 250 is illustrated as a vertical device which (for example) provides one or more apertures which are substantially parallel to the horizontal (x-y) plane A in which the top surface 246 of substrate 242 extends. However, one or more components of optical device 250 alternatively have an edge/facet coupled architecture.

In an embodiment, optical device 250 comprises one or more emitters (such as the illustrative lasers 252 shown). A given one such emitter, in accordance with some embodiments, is operable to emit radiation at some suitable center wavelength (λ), but in some examples, emits over an IR (or other) band of the electromagnetic spectrum-e.g., in a near IR wavelength band of 850 nanometers (nm) to 940 nm. In various exemplary embodiments, at least one of lasers 252 comprises a laser diode. In some vertical emission embodiments, at least one of lasers 252 is a vertical-cavity surface-emitting laser (VCSEL). In other embodiments, at least one of lasers 252 is a light emitting diode (LED), and more specifically a μLED.

In some exemplary embodiments, one of lasers 252 emits at a first center wavelength (λ₁) and a different one of lasers 252 emits at a second center wavelength (λ₂). In some embodiments, λ₁ differs from λ₂ by at least 1 nm, and advantageously by at least 5 nm, or more. In some exemplary near IR band embodiments, λ₁ is approximately 850 nm and λ₂ is approximately 880nm (i.e., a 30 nm difference between λ₁ and λ₂). For such embodiments, additional lasers 252 may similarly emit other center wavelengths, for example all separated by approximately 30 nm.

In an embodiment, a given one of photodetectors 254 have any of various suitable semiconductor architectures, such as a p-n photodiode, p-i-n photodetector, Schottky barrier photodetector, or metal-semiconductor-metal (MSM) photodetector. For example, a given one of photodetectors 254 has broadband responsivity or, alternatively, narrowband responsivity (e.g., a resonant-cavity-enhanced architecture). In some embodiments, two or more of photodetectors 254 have responsivity tuned to a same center wavelength. In an illustrative scenario according to one embodiment, a given one of photodetectors 254 has a peak responsivity in a near IR band—e.g., in a wavelength range of 850 nm to 880 nm. In one such embodiment, one or more others of photodetectors 254 similarly have peak responsivity at other center wavelengths, for example all separated by approximately 30 nm.

In various embodiments, optical device 250 comprises a first emitter (e.g., a laser) and a first photodetector which are variously coupled to communicate via the same one of waveguides 244. The first emitter and first photodetector may, for example, comprise a pairing of receiver and transmitter devices that are advantageously operable together as a bidirectional transceiver of waveguide (WG) 244a (or another of WGs 244). For such embodiments, the first photodetector has responsivity over one or more center wavelengths—e.g., wherein the first emitter is operable to emit over a same or different center wavelength.

In some embodiments, optical communication device 210 is mounted onto PIC 240, adhered to a vertical side of PIC 240, or otherwise attached for direct or indirect rigid coupling with PIC 240. By way of illustration and not limitation, optical communication device 210 is adhered or otherwise physically attached onto a printed circuit board—or other suitable support structure (not shown)—onto which PIC 240 is also attached. In an embodiment, optical communication device 210 comprises a main body portion 212 including (for example) a plastic mold, a housing and/or any of various other suitable support structures. Device 210 further comprise a plurality of multi-core fibers 214 (generically referred to herein each as a fiber 214) which variously extend through main body portion 212. The fibers 214 each form a respective one or more optical interface surfaces (OISs) of optical communication device 210. Optical communication device 210 is any of various suitable fiber array unit (FAU) devices, for example.

In the example embodiment shown, a fiber 214a of optical communication device 210 comprises a cladding 216a, which is surrounded by main body portion 212, and multiple cores 215a which extend, through cladding 216a, to a side of optical communication device 210. Similarly, a fiber 214b of optical communication device 210 comprises a cladding 216b, which is surrounded by main body portion 212, and multiple cores 215b which extend, through cladding 216b, to that same side of optical communication device 210. The particular number of the multiple cores 215 in a given fiber 214 is not limiting on some embodiments.

In an embodiment, a given core 215 has any of various suitable compositions, but in exemplary embodiments is of a glass, such as one which is suitable for IR (or other) band transmission. In various embodiments, a core 215 comprises any of various glasses which include (for example) SiO₂, SiO₂ doped with GeO₂, germanosilicate, phosphorus pentoxide, phosphosilicate, A1₂O₃, aluminosilicate, or the like, or any combinations thereof. A given cladding 216 may also be of a glass having sufficient index contrast with a corresponding core 215 to sustain internal reflection of one or more guided optical core modes.

In accordance with some embodiments, a core 215 is a multi-mode (MM) core suitable for propagation of multiple core modes. With a sufficient cross-sectional diameter, a core 215 supports the propagation of more than one transverse optical mode (e.g., LP₀₁, LP₀₂, LP₁₁, etc.). In exemplary MM embodiments, such a cross-sectional diameter is approximately 50 μm (e.g., OM3 or OM4 of ISO/IEC 11801). In alternative MM embodiments, such a cross-sectional diameter is approximately 62 μm (e.g., OM1 of ISO/IEC 11801). In accordance with other embodiments, a core 215 is a single-mode (SM) core suitable for the propagation of only one transverse optical mode (e.g., LP₀₁). In exemplary SM embodiments, a cross-sectional diameter of such a core 215 is less than 10 μm (e.g., ~9 μm).

In an embodiment, respective ends of the cores 215 each to form a respective one of multiple optical interface surfaces (OISs) 218 at such a side of optical communication device 210—e.g., wherein the side substantially extends in the illustrative vertical (y-z) plane B shown. In one such embodiment, fiber cores 215 are variously ground and/or polished each to form a different respective OIS 218—e.g., with sufficient flatness and a suitable angle relative to the z-axis. Although OISs 218 are shown as each being in the vertical (y-z) plane B which is perpendicular to the fiber axial length (i.e., a 0° face angle), an OIS 218 may be at any of various other suitable angles (e.g., <10° face angle, etc.).

In various embodiments, fibers 214 form a 2D array at said side of optical communication device 210—e.g., wherein a first row of the 2D array comprises some or all of an end of fiber 214a, and wherein a second row of the 2D array comprises some or all of an end of fiber 214b. In one such embodiment, each of fibers 214 forms a different respective subgroup of OISs of the multiple OISs 218, wherein the 2D array comprises an array of the subgroups of OISs 218.

In the example embodiment shown, the OISs 218 comprise first OISs which are in the first row of the 2D array and which are formed each by a different respective one of the cores 215a. Furthermore, the OISs 218 comprise second OISs which are in the second row of the 2D array, and which are formed each by a different respective one of the cores 215b. In one such embodiment, PWBs 230 comprise PWBs 230a which are each optically coupled between a respective one of the first OISs and a respective one of WGs 244. Furthermore, PWBs 230 comprise PWBs 230b which are each optically coupled between a respective one of the second OISs and a respective one of WGs 244.

PWBs 230 operate as waveguide structures each to propagate a respective one or more optical modes to/from a corresponding OIS 218 to one or more apertures of lasers 252 and/or photodetectors 254. In exemplary embodiments, a PWB 230 has a composition distinct from that of a fiber core 215 which is optically coupled thereto. For example, a PWB 230 may be other than glass, and instead comprise one or more materials of a suitably high refractive index. In an embodiment, a PWB 230 is of a material derived from a precursor solution dispensed by direct printing processes described in methods 100 (FIG. 1). In an embodiment, a PWB 230 is printed, for example, following attachment of lasers 252 and/or photodetectors 254 and positioning (and, for example, attachment) of optical communication device 210.

In some embodiments, PWBs 230 all have substantially the same chemical composition. One or more of PWBs 230 may advantageously be a polymer material. In some embodiments, the polymer material comprises one or more organic compounds. The polymer material may, for example, comprise polystyrene, methyl polymethacrylate, polycarbonate, perfluorinated compounds (PFCs) such as amorphous fluoropolymers. The polymer material may also comprise polyimides, epoxy compounds such as SU-8, or optoelectronic π-conjugated polymers (CP). Each PWB 230 may be substantially homogenous in composition. Each PWBs 230 may be surrounded by free-space (e.g., air), or may be embedded within one or more cladding or coating materials (not depicted).

In the example embodiment shown, some or all of the PWBs 230 are configured each to facilitate evanescent optical coupling with a respective one of waveguide structures 244. In some embodiments, a portion of a given PWB 230 is freely suspended above, or over, substrate 242 to form a gap between that PWB 230 and plane A. Being at least partially stood-off from plane A in a manner similar to an electrical bond wire, such a PWB 230 functions as an optical waveguide that is structurally distinguishable from a planar optical waveguide (such as one of waveguide structures 244) which is confined to substrate 242 in a manner more analogous to an electrical trace than an electrical bond wire. In some embodiments, a gap between plane A and one of PWBs 230 is backfilled with any of various intervening materials (not depicted) that are suitable to maintain an adequate index contrast with that one of PWBs 230.

FIG. 2C shows a side view of a photonic wire bond (PWB) 230x to provide optical coupling according to an embodiment. The PWB 230x illustrates an example of one of the PWBs 230 which accommodate coupling between one of the waveguide structures 244 of PIC 240 and a core 215 of optical communication device 210. In various embodiments, the fabrication, coupling and/or use of PWB 230x includes or is otherwise based on one or more operations of methods 100. However, PWB 230x may also be fabricated and/or used according to alternative methods, in other embodiments.

In the example embodiment shown, PWB 230a comprises a taper portion 232—for example, comprising an adiabatic taper—which, in some embodiments, is 3D printed or otherwise fabricated to facilitate a progressive decrease in a thickness dimension (e.g., a diameter). Taper portion 232 facilitates the prevention or suppression of high order modes in an optical signal. Such a high order mode is a risk where, for example, there is a refractive index increase along a path from the core (or other structure) which forms the OIS to the PWB 230x. Alternatively or in addition, such a high order mode is a risk where the structure which forms the OIS is surrounded by a cladding, while PWB 230x is not surrounded by any cladding.

In some embodiments, one or more dimensions of taper portion 232 are suitable to prevent or otherwise mitigate the risk of a desired mode of an optical signal leaking from PWB 230 and (for example) into free space. By way of illustration and not limitation, a length x1 of taper portion 232 is in a range of 100 microns (μm) to 1000 μm—e.g., wherein a thickness z1 at a wider end of of taper portion 232 is in a range of 5 μm to 10 μm, and a thickness z2 at a narrower and of taper portion 232 is in a range of 1 μm to 5 μm. However, taper portion 232 includes any of various other length dimensions and/or thickness dimensions, in different embodiments.

In an embodiment, the taper portion 232 extends to a curved portion 234 in which PWB 230x bends in any of various suitable shapes-and/or between any of various arbitrary positions-as dictated by implementation-specific requirements. Although shown as forming only a single continuous arc, curved portion 234 alternatively forms multiple arc structures which (for example) have different respective bending radii, different respective directions of concavity, and/or the like. In various embodiments, a bending radius r1 of curved portion 234 exceeds a critical radius, below which an optical signal would leak from PWB 230x. By way of illustration and not limitation, the radius r1 of curved portion 234 is in a range of 5 μm to 50 μm—e.g., wherein an overall vertical span of curved portion 234 is in a range of 10 μm to 100 μm, and/or an overall horizontal span of curved portion 234 is in a range of 10 μm to 100 μm. However, curved portion 234 includes any of various other bending radii, vertical spans and/or horizontal spans, in different embodiments.

In some embodiments, curved portion 234 extends to a coupler portion 236 by which PWB 230x is to be optically coupled (for example) to a waveguide structure 244 of PIC 240. In one such embodiment, coupler portion 236 is placed against (or printed on) a portion of top surface 246 which a corresponding waveguide structure 244 extends to or under. In an example embodiment, the corresponding waveguide structure 244 overlaps with an evanescent field of an optical mode which is communicated in the coupler portion 236, enabling the optical mode to transfer into the corresponding waveguide structure 244 with little or no leakage into free space (or into another adjoining structure). Alternatively, the overlapping of coupler portion 236 with the corresponding waveguide structure 244 enables an optical mode to be transferred from the waveguide structure 244 to PWB 230x. This phenomenon is referred to as evanescent coupling (EVC).

In some embodiments, one or more dimensions of coupler portion 236 facilitate evanescent coupling between PWB 230x and a corresponding one of waveguide structures 244. In an illustrative scenario according to one embodiment, a length x2 of coupler portion 236 is in a range of 50 μm to 500 μm. However, coupler portion 236 includes any of various other length dimensions, in different embodiments. To facilitate EVC in some embodiments, coupler portion 236 further exhibits horizontal (y-dimension) tapering as it extends along another horizontal (x-dimension) path away from curved portion 234.

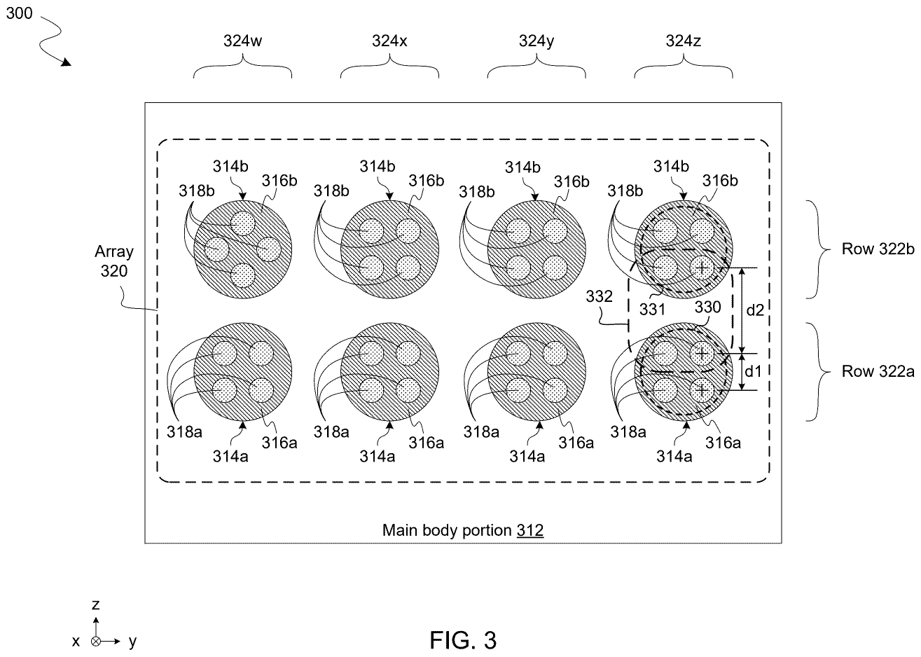

FIG. 3 shows an end view of an optical communication device 300 comprising optical interface surfaces which are arranged, in a two-dimensional array, to accommodate optical coupling with PWBs according to an embodiment. The view shown in FIG. 3 corresponds (for example) to the plane B which is indicated in FIG. 1. In some embodiments, optical communication device 300 provides functionality such as that of optical communication device 210—e.g., wherein operations of methods 100 are performed with, or provide structures of, optical communication device 300. However, some or all structures of optical communication device 300 may also be fabricated and/or used according to alternative methods, in other embodiments.

As shown in FIG. 3, optical communication device 300 comprises a main body portion 312 and multi-core fibers 314 which variously extend though main body portion 312 e.g., wherein main body portion 312 and fibers 314 correspond functionally to main body portion 212 and fibers 214 (respectively). In an embodiment, fibers 314 are arranged to form, at least part, a 2D array 320. By way of illustration and not limitation, array 320 comprises a row 322a of the respective ends of fibers 314a and another row 322b of the respective ends of fibers 314b. The array 320 further comprises columns (in this example, the illustrative columns 324w-342z shown) which each include an end of a different respective one of fibers 314a and an end of a different respective one of fibers 314b.

In one such embodiment, each fiber 314a comprises a respective cladding 316a and a respective plurality of cores which extend through the respective cladding 316a. For each of fibers 314a, the cores of the fiber 314a each end to form a respective one of OISs 318a. Similarly, each fiber 314b comprises a respective cladding 316b and a respective plurality of cores which extend through the respective cladding 316b. For each of fibers 314b, the cores of the fiber 314b each end to form a respective one of OISs 318b.

In an embodiment, each of the multi-core fibers 314 forms a respective group of OISs 318, wherein array 320 comprises a 2D array of such OIS groups. For example, multiple OIS groups of array 320 each correspond to (for example, are formed by) a different respective one of the multi-core fibers 314, wherein some or all of the multiple OIS groups are congruent with each other. By way of illustration and not limitation, a first one of fibers 314a, which is both in row 322a and in column 324z, comprises a first group 330 of OISs 318a. Furthermore, a first one of fibers 314b, which is both in row 322 b and in column 324z, comprises a second group 331 of OISs 318b. In an embodiment, an arrangement of the OISs 318a of group 330 relative to each other is congruent to (e.g., is substantially the same as) an arrangement of the OISs 318b of group 331 relative to each other.

In one such embodiment, optical communication device 300 forms another OIS group (such as the illustrative OIS group 332 shown) which at least partially spans two (or more) of fibers 314. For example, OIS group 332 includes some cores of fiber 314a, and some cores of fiber 314b—e.g., wherein a total number of the OISs 318 of OIS group 332 is the same as a total number of the OISs 318 of OIS group 330 (or of OIS group 331). However, an arrangement of the OISs 318 of group 332 relative to each other is incongruent to the arrangement of the OISs 318 of group 330 (or of group 331). By way of illustration and not limitation, an incongruency between OIS group 332 and either of groups 330, 331 is due in part to a difference between a distance d1, between OISs which are each in the same one of groups 330, 331, and a distance d2 between OISs which are each in a different respective one of groups 330, 331.

In other embodiments such an arrangement of OISs is additionally or alternatively provided by a connector—e.g., an expanded beam connector (EBC)—which is to be coupled to a device such as optical communication device 300. In one such embodiment, this arrangement of OISs is provided with micro-lenses and of waveguides of said connector.

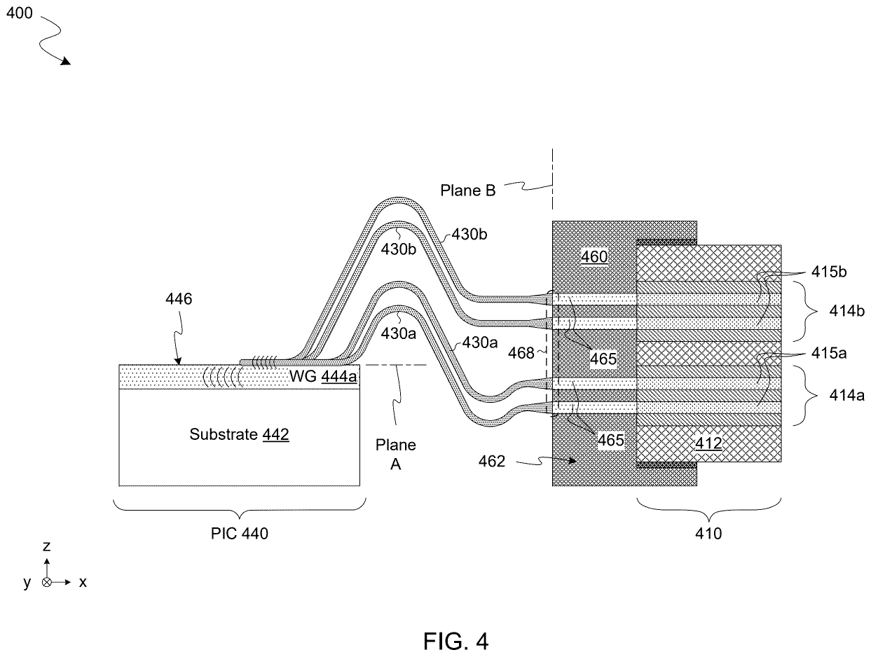

FIG. 4 shows a cross-sectional side view of a system 400 comprising photonic wire bonds which variously facilitate use of an optical coupler device according to an embodiment. System 400 illustrates features of one example embodiment wherein a coupler device enables (re)coupling PWBs to multi-core fibers which are arranged in a 2D array. In some embodiments, system 400 provides functionality such as that of system 200—e.g., wherein the fabrication, coupling and/or use of some or all structures of system 400 include operations of methods 100. However, some or all structures of system 400 may also be fabricated according to alternative methods, in other embodiments.

As shown in FIG. 4, system 400 comprises an optical communication device 410, a PIC 440, and PWBs 430 (such as the illustrative PWBs 430a and PWBs 430b shown) which variously facilitate optical coupling between optical communication device 410 and PIC 440. In this particular example, a connector device 460 of system 400 enables coupling (and, for example, decoupling and recoupling) of PWBs 430 each to a respective optical structure of optical communication device 410. In an embodiment, PIC 440 and PWBs 430 provide functionality such as that of PIC 240 and PWBs 230, respectively-e.g., wherein optical communication device 410 has some or all of the features of optical communication device 210 (or of optical communication device 300, for example).

In an embodiment, optical communication device 410 comprises a main body portion 412 including (for example) a plastic mold, a housing and/or any of various other suitable support structures. Device 410 further comprise a plurality of multi-core fibers 414 (generically referred to herein each as a fiber 414) which variously extend through main body portion 412. The fibers 414 each form a respective one or more optical interface surfaces (OISs) of optical communication device 410. For example, cores 415a of a fiber 414a, and cores 415b of a fiber 414b, variously extend through main body portion 412, each to form a respective one of multiple OISs at a side of optical communication device 410. In one such embodiment, the fibers 414 are arranged in a 2D array (such as array 320) at said side of optical communication device 410 e.g., wherein a first row of the 2D array comprises fiber 414a, and wherein a second row of the 2D array comprises fiber 414b. For example, fibers 414 have features of fibers 214, in some embodiments.

In an embodiment, connector device 460 comprises a housing 462—e.g., including a plastic (or other) support structure- and multiple waveguides 465 which variously extend through housing 462. Device 410 further comprise a plurality of waveguides 465 which variously extend through housing 462. The waveguides 465 each form a respective one of multiple optical interface surfaces (OISs) 468 at a side of connector device 460—e.g., wherein the side is in the illustrative vertical (y-z) plane B shown. In one example embodiment, OISs 468 are arranged in a 2D array of OIS groups-e.g., wherein the arrangement of OISs 468 in said 2D array is similar to that of the OISs 318 in 2D array 320.

In an embodiment, PWBs 430 are each optically coupled to a different respective one of the OISs 468, wherein—when optical communication device 410 is brought into contact with a first side of connector device 460—cores 415 are each optically coupled to a respective one of PWBs 430 via a respective one of waveguides 465. In various embodiments, PWBs 430 each facilitate communication of optical signals between a respective one of OISs 468 and a respective one of waveguides (e.g., including the illustrative waveguide structure 444a shown) which extend under—and, for example, to—a top surface 446 of a substrate 442. For example, some PWBs 430a variously enable communication with a first (horizontal) row of a 2D array formed by OISs 468, whereas other PWBs 430b variously enable communication with a second row of said 2D array.

In some embodiments, the top surface 446 of PIC 440 extends substantially in a horizontal (x-y) plane A, wherein one or more of the OISs 468 are vertically below the plane A, and (for example) wherein one or more others of the OISs 468 are vertically above the plane A. For example, PWBs 230a extend through the plane A, whereas PWBs 230b are entirely above the plane A, in some embodiments.

Alternatively or in addition, some or all of PWB 230 comprise respective curved portions which extend along different respective paths between connector device 460 and top surface 446. By way of illustration and not limitation, one of PWBs 230 has a first total number of local extrema points (wherein a local extrema point is a local maxima point or a local minima point), whereas another of PWBs 230 has a different total number of local extrema points. In one such embodiment, one of PWBs 230a comprises both a first section which is concave in a first (“upward”) vertical direction, and a second section which is concave in a second (“downward”) vertical direction, wherein the first section forms a local minima point, and wherein the second section forms a local maxima point. By contrast, one of PWBs 230b comprises a section which is concave in the downward vertical direction (and which forms a local maxima point), but omits any section which is concave in the upward vertical direction and which forms a local minima point.

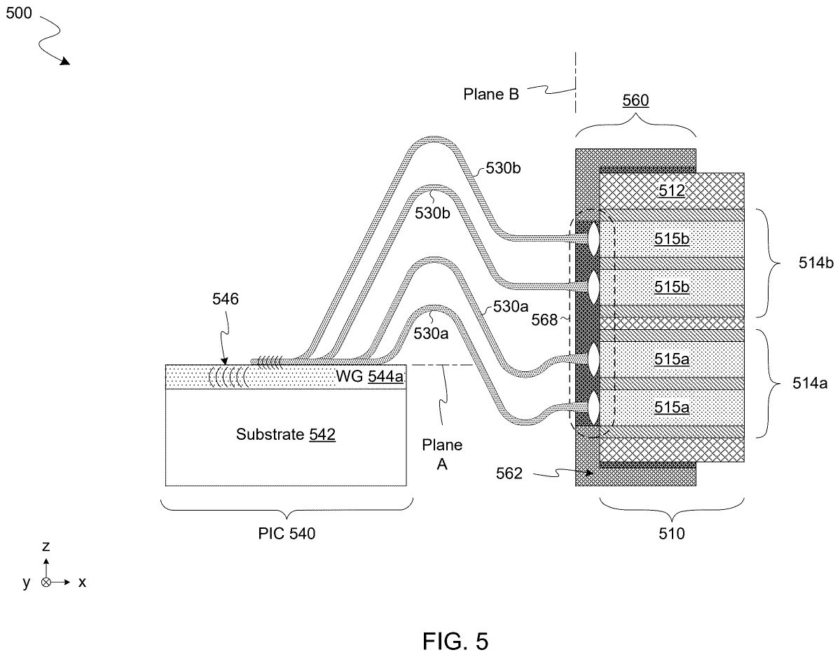

FIG. 5 shows a side view diagram illustrating features of a system 500 comprising photonic wire bonds which variously form routes for optical coupling of micro-lenses with a PIC according to an embodiment. System 500 illustrates features of another example embodiment wherein a coupler device enables (re)coupling PWBs to OISs which are arranged in a 2D array. In some embodiments, system 500 provides functionality such as that of system 200 or system 400-e.g., wherein the fabrication, coupling and/or use of some or all structures of system 500 include operations of methods 100.

As shown in FIG. 5, system 500 comprises an optical communication device 510, a PIC 540, PWBs 530, and a connector device 560 which-for example-correspond functionally to optical communication device 410, PIC 440, PWBs 430, and connector device 460. PIC 540 (having features of PIC 240, for example) comprises a substrate 542 and waveguides variously formed therein or thereon-e.g., the waveguides including the illustrative WG 544a shown. In an embodiment, optical communication device 510 comprises a main body portion 512 and a plurality of multi-core fibers 514 which variously extend through main body portion 512. For example, cores 515a of a fiber 514a, and cores 515b of a fiber 514b, variously extend through main body portion 512, each to form a respective one of multiple OISs at a side of optical communication device 510. In one such embodiment, the fibers 514 are arranged in a 2D array (such as array 320) at said side of optical communication device 510—e.g., wherein a first row of the 2D array comprises fiber 514a, and wherein a second row of the 2D array comprises fiber 514b. For example, fibers 514 have features of fibers 414, in some embodiments.

In an embodiment, connector device 560 comprises a housing 562 and multiple micro-lenses which variously extend through housing 562. Device 560 further comprises a plurality of micro-lenses 568 which are each disposed in, or aligned with, a respective aperture structure which is formed with housing 562. The micro-lenses 568 each form a respective OIS which is configured to communicate an optical signal which propagates via a side of connector device 560—e.g., wherein the side is in the illustrative vertical (y-z) plane B shown. In one example embodiment, micro-lenses 568 are arranged to form a 2D array of OIS groups—e.g., wherein the arrangement of OISs in said 2D array is similar to that of the OISs 318 in 2D array 320.

In an embodiment, PWBs 530 are each optically coupled to a different respective one of the micro-lenses 568, wherein-when optical communication device 510 is brought into contact with a first side of connector device 560—cores 515 are each optically coupled to a respective one of PWBs 530 via a respective one of micro-lenses 568. Some or all of PWBs 530 are variously configured each to facilitate evanescent coupling, at a surface 546 of PIC 540, with a different respective waveguide. In the example embodiment shown, some PWBs 530a variously enable communication with a first (horizontal) row of a 2D array formed by micro-lenses 568, whereas other PWBs 530b variously enable communication with a second row of said 2D array. In various embodiments, PWBs 530 variously comprise features of PWBs 430, for example.

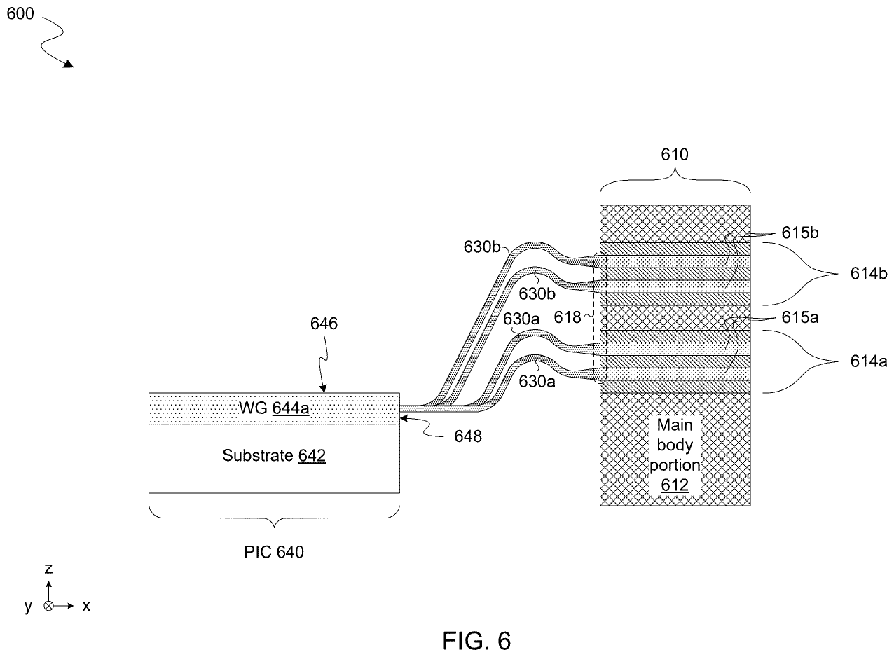

FIG. 6 shows a cross-sectional side view of a system 600 comprising photonic wire bonds which are variously coupled each to an edge of a respective waveguide of a PIC according to an embodiment. System 600 illustrates another example embodiment wherein PWBs are coupled to OISs which are arranged in a 2D array. In some embodiments, system 600 provides functionality such as that of system 200, system 400 or system 500—e.g., wherein operations of methods 100 fabricate, couple and/or use structures of system 600.

As shown in FIG. 6, system 600 comprises an optical communication device 610, a PIC 640, and PWBs 630 which-for example-correspond functionally to optical communication device 210, PIC 240, and PWBs 230. PIC 640 (having features of PIC 240, for example) comprises a substrate 642 and waveguides variously formed therein or thereon-e.g., the waveguides including the illustrative waveguide WG 644a shown. In an embodiment, optical communication device 610 comprises a main body portion 612 and a plurality of multi-core fibers 614 which variously extend through main body portion 612. For example, cores 615a of a fiber 614a, and cores 615b of a fiber 614b, variously extend through main body portion 612, each to form a respective one of multiple OISs 618 at a side of optical communication device 610. In one such embodiment, the fibers 614 are arranged in a 2D array (such as array 320) at said side of optical communication device 610—e.g., wherein fibers 614a, 614b are in different respective rows of the 2D array. For example, fibers 614 have features of fibers 214, in some embodiments.

In an embodiment, PWBs 630 are each optically coupled to a different respective one of OISs 618, wherein cores 615 are each optically coupled to a respective one of PWBs 630 via a respective one of OISs 618. In the example embodiment shown, some PWBs 630a variously enable communication with a first (horizontal) row of a 2D array formed by OISs 618, whereas other PWBs 630b variously enable communication with a second row of said 2D array. In various embodiments, PWBs 630 variously comprise features of PWBs 230, for example.

In various embodiments, PWBs 630 are variously coupled edgewise each to a different respective waveguide (WG) of PIC 640. For example, a WG 644a extends to a vertical (y-z) side 648 of PIC 640, wherein the WG 644a optically couples to a PWB 630a. Such edgewise coupling is to be distinguished from evanescent coupling which is provided-via a top surface 646, for example-according to other embodiments described herein. In some embodiments, PIC 640 forms, or is coupled to, any of various suitable anchor structures (not shown) which provide structural support for some or all PWBs 630 at side 648.

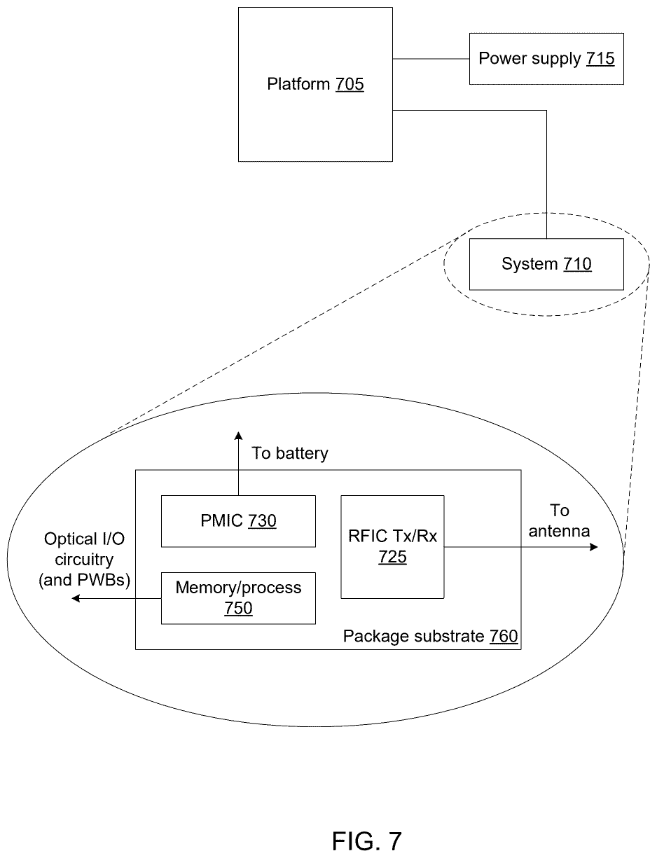

The photonic device assemblies and systems described herein may be implemented in a wide variety of applications and platforms. FIG. 7 illustrates a mobile computing or data server platform 705 employing an optical link with multiplexed optical wire fiber termination, for example as described elsewhere herein. Platform 705 may be any commercial server, for example including any number of high-performance computing platforms disposed within a rack and networked together for electronic data processing. The platform 705 may also be any portable device configured for each of electronic data display, electronic data processing, wireless electronic data transmission, or the like. For example, the platform 705 may be any of a tablet, a smart phone, laptop computer, etc., and may include an integrated or disintegrated system 710, and a power supply 715.

As illustrated in the expanded view, a package substrate 760 is coupled to one or more of a power management integrated circuit (PMIC) 730 or RF (wireless) integrated circuit (RFIC) 725 including a wideband RF (wireless) transmitter and/or receiver. PMIC 730 may perform battery power regulation, DC-to-DC conversion, etc., and has an input coupled to power supply 715 and an output providing a current supply to other functional modules. RFIC 725 has an output coupled to an antenna (not shown) to implement any of a number of wireless standards or protocols, including but not limited to Wi-Fi (IEEE 802.11 family), WiMAX (IEEE 802.18 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, and beyond.

Integrated system 710 further comprises a memory and/or processor 750, one or more of which are coupled to optical data links which include, or are operated by, optical input/output (I/O) circuitry to transmit and/or receive optical communications through PWBs, for example as described elsewhere herein.

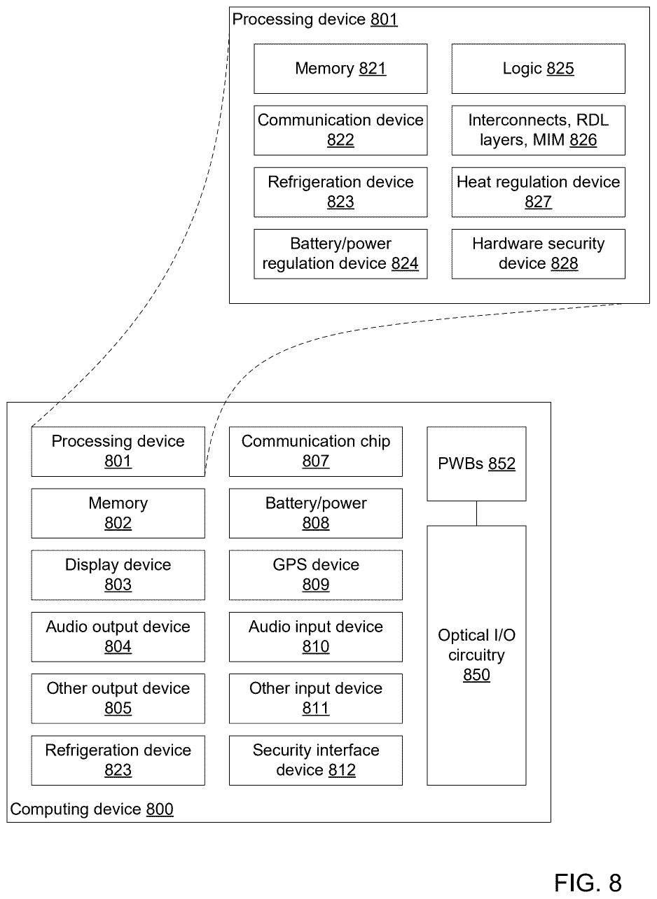

FIG. 8 is a block diagram of a cryogenically cooled computing device 800 in accordance with some embodiments. For example, one or more components of computing device 800 may include any of the optical devices or fiber multiplexing structures discussed elsewhere herein. A number of components are illustrated in FIG. 8 as included in computing device 800, but any one or more of these components may be omitted or duplicated, as suitable for the application. In some embodiments, some of the components included in computing device 800 may be attached to one or more printed circuit boards (e.g., a motherboard). In some embodiments, various ones of these components may be fabricated onto a single system-on-a-chip (SoC) die or implemented with a disintegrated plurality of chiplets or tiles packaged together. Additionally, in various embodiments, computing device 800 may not include one or more of the components illustrated in FIG. 8, but computing device 800 may include interface circuitry for coupling to the one or more components. For example, computing device 800 may not include a display device 803, but may include display device interface circuitry (e.g., a connector and driver circuitry) to which display device 803 may be coupled.

Computing device 800 may include a processing device 801 (e.g., one or more processing devices). As used herein, the term processing device or processor indicates a device that processes electronic data from registers and/or memory to transform that electronic data into other electronic data that may be stored in registers and/or memory. Processing device 801 may include a memory 821, a communication device 822, a refrigeration/active cooling device 823, a battery/power regulation device 824, logic 825, interconnects 826, a heat regulation device 827, and a hardware security device 828.

Processing device 801 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

Processing device 801 may include a memory 802, which may itself include one or more memory devices such as volatile memory (e.g., dynamic random-access memory (DRAM)), nonvolatile memory (e.g., read-only memory (ROM)), flash memory, solid state memory, and/or a hard drive. In some embodiments, processing device 801 shares a package with memory 802. This memory may be used as cache memory and may include embedded dynamic random-access memory (eDRAM) or spin transfer torque magnetic random-access memory (STT-M RAM).

Computing device 800 may include a heat regulation/refrigeration device 823. Heat regulation/refrigeration device 823 may maintain processing device 801 (and/or other components of computing device 800) at a predetermined low temperature during operation. This predetermined low temperature may be any temperature discussed elsewhere herein.

In some embodiments, computing device 800 may include a communication chip 807 (e.g., one or more communication chips). For example, the communication chip 807 may be configured for managing wireless communications for the transfer of data to and from computing device 800. The term “wireless” and its derivatives may be used to describe circuits, devices, systems, methods, techniques, communications channels, etc., that may communicate data through the use of modulated electromagnetic radiation through a nonsolid medium.

Communication chip 807 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. Communication chip 807 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. Communication chip 807 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication chip 807 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication chip 807 may operate in accordance with other wireless protocols in other embodiments. Computing device 800 may include optical input/output (I/O) circuitry 850 to transmit and/or receive optical communications through PWBs 852, for example as described elsewhere herein.

In some embodiments, communication chip 807 may manage wired communications, such as electrical, optical, or any other suitable communication protocols (e.g., the Ethernet). As noted above, communication chip 807 may include multiple communication chips. For instance, a first communication chip 807 may be dedicated to shorter-range wireless communications such as Wi-Fi or Bluetooth, and a second communication chip 807 may be dedicated to longer-range wireless communications such as GPS, EDGE, GPRS, CDMA, WiMAX, LTE, EV-DO, or others. In some embodiments, a first communication chip 807 may be dedicated to wireless communications, and a second communication chip 807 may be dedicated to wired communications.

Computing device 800 may include battery/power circuitry 808. Battery/power circuitry 808 may include one or more energy storage devices (e.g., batteries or capacitors) and/or circuitry for coupling components of computing device 800 to an energy source separate from computing device 800 (e.g., AC line power).

Computing device 800 may include a display device 803 (or corresponding interface circuitry, as discussed above). Display device 803 may include any visual indicators, such as a heads-up display, a computer monitor, a projector, a touchscreen display, a liquid crystal display (LCD), a light-emitting diode display, or a flat panel display, for example.

Computing device 800 may include an audio output device 804 (or corresponding interface circuitry, as discussed above). Audio output device 804 may include any device that generates an audible indicator, such as speakers, headsets, or earbuds, for example.

Computing device 800 may include an audio input device 810 (or corresponding interface circuitry, as discussed above). Audio input device 810 may include any device that generates a signal representative of a sound, such as microphones, microphone arrays, or digital instruments (e.g., instruments having a musical instrument digital interface (MIDI) output).

Computing device 800 may include a global positioning system (GPS) device 809 (or corresponding interface circuitry, as discussed above). GPS device 809 may be in communication with a satellite-based system and may receive a location of computing device 800, as known in the art.

Computing device 800 may include another output device 805 (or corresponding interface circuitry, as discussed above). Examples include an audio codec, a video codec, a printer, a wired or wireless transmitter for providing information to other devices, or an additional storage device.

Computing device 800 may include another input device 811 (or corresponding interface circuitry, as discussed above). Examples may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 800 may include a security interface device 812. Security interface device 812 may include any device that provides security measures for computing device 800 such as intrusion detection, biometric validation, security encode or decode, managing access lists, malware detection, or spyware detection.

Computing device 800, or a subset of its components, may have any appropriate form factor, such as a hand-held or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device.

In one or more first embodiments, a device, comprises a communication device comprising multiple optical interface surfaces (OISs) which each correspond to a respective multi-core fiber of a two-dimensional (2D) array of multi-core fibers, a photonic integrated circuit (PIC) comprising a substrate and multiple waveguide structures in or on the substrate, and multiple photonic wire bond (PWB) structures each optically coupled between a respective one of the multiple OISs, and a respective one of the waveguide structures.

In one or more second embodiments, further to the first embodiment, the multiple waveguide structures comprise a first waveguide structure, and the multiple PWB structures comprise a first PWB structure which extends over a top surface of the first waveguide structure.

In one or more third embodiments, further to the first embodiment or the second embodiment, the multiple OISs are arranged in an M x N array of groups which each consist of a respective X OISs, M, N and X are respective integers each greater than one, the groups comprise a first group and a second group which is substantially congruent with the first group, a first X OISs of the multiple OISs span the first group and the second group, and an arrangement of the first X OISs is substantially incongruent with the first group.

In one or more fourth embodiments, further to any of the first through third embodiments, the multiple PWB structures each extend to a first surface of the PIC, the first surface extends substantially in a horizontal plane, and the multiple OISs comprise a first plurality of OISs which are each located vertically below the horizontal plane, and a second plurality of OISs which are each located vertically above the horizontal plane.

In one or more fifth embodiments, further to any of the first through fourth embodiments, the communication device comprises the multi-core fibers.

In one or more sixth embodiments, further to any of the first through fifth embodiments, the communication device is a connector to be coupled to another device which comprises the multi-core fibers.

In one or more seventh embodiments, further to any of the first through sixth embodiments, the multiple OISs comprise micro-lenses.

In one or more eighth embodiments, further to any of the first through seventh embodiments, the multiple PWB structures comprise a first PWB structure comprising a first taper portion and a first curved portion which extends from the first taper portion, and a second PWB structure comprising a second taper portion and a second curved portion which extends from the second taper portion, and wherein a first total number of local extrema points of the first curved portion is different than a second total number of local extrema points of the second curved portion.

In one or more ninth embodiments, further to any of the first through eighth embodiments, the multiple PWB structures comprise a first PWB structure comprising a first taper portion and a first curved portion which extends from the first taper portion, and the first curved portion comprises a first section which is concave in a first vertical direction, and a second section which is concave in a second vertical direction which is opposite the first vertical direction.

In one or more tenth embodiments, a system comprises a photonic integrated circuit (PIC) comprising a substrate and multiple waveguide structures in or on the substrate, a plurality of multi-core fibers which form multiple optical interface surfaces (OISs), and multiple photonic wire bond (PWB) structures each optically coupled between a respective one of the multiple OISs and a respective one of the waveguide structures, wherein the multiple OISs are arranged in an M x N array of groups which each consist of a respective X OISs, M, N and X are respective integers each greater than one, the groups comprise a first group and a second group which is substantially congruent with the first group, a first X OISs of the multiple OISs span the first group and the second group, and an arrangement of the first X OISs is substantially incongruent with the first group.

In one or more eleventh embodiments, further to the tenth embodiment, the multiple waveguide structures comprise a first waveguide structure, and the multiple PWB structures comprise a first PWB structure which extends over a top surface of the first waveguide structure.

In one or more twelfth embodiments, further to the tenth embodiment or the eleventh embodiment, the multiple PWB structures each extend to a first surface of the PIC, the first surface extends substantially in a horizontal plane, and the multiple OISs comprise a first plurality of OISs which are each located vertically below the horizontal plane, and a second plurality of OISs which are each located vertically above the horizontal plane.

In one or more thirteenth embodiments, further to any of the tenth through twelfth embodiments, further comprising a connector which is coupled between the multi-core fibers and the multiple PWB structures.

In one or more fourteenth embodiments, further to any of the tenth through thirteenth embodiments, the connector comprises micro-lenses.

In one or more fifteenth embodiments, further to any of the tenth through fourteenth embodiments, the multiple PWB structures comprise a first PWB structure comprising a first taper portion and a first curved portion which extends from the first taper portion, and a second PWB structure comprising a second taper portion and a second curved portion which extends from the second taper portion, and wherein a first total number of local extrema points of the first curved portion is different than a second total number of local extrema points of the second curved portion.

In one or more sixteenth embodiments, further to any of the tenth through fifteenth embodiments, the multiple PWB structures comprise a first PWB structure comprising a first taper portion and a first curved portion which extends from the first taper portion, and the first curved portion comprises a first section which is concave in a first vertical direction, and a second section which is concave in a second vertical direction which is opposite the first vertical direction.

In one or more seventeenth embodiments, a method comprises attaching a communication device to a substrate, the communication device comprising multiple optical interface surfaces (OISs) which each correspond to a respective multi-core fiber of a two-dimensional (2D) array of multi-core fibers, wherein multiple waveguide structures are in or on the substrate, attaching two or more optical devices to the substrate, and printing multiple photonic wire bond (PWB) structures which each extend between a respective one of the multiple OISs, and a respective one of the waveguide structures.

In one or more eighteenth embodiments, further to the seventeenth embodiment, the multiple PWB structures are printed with a two-photon polymerization process.

In one or more nineteenth embodiments, further to the seventeenth embodiment or the eighteenth embodiment, the multiple waveguide structures comprise a first waveguide structure, and the multiple PWB structures comprise a first PWB structure which extends over a top surface of the first waveguide structure.

In one or more twentieth embodiments, further to any of the seventeenth through nineteenth embodiments, the multiple OISs are arranged in an M×N array of groups which each consist of a respective X OISs, M, N and X are respective integers each greater than one, the groups comprise a first group and a second group which is substantially congruent with the first group, a first X OISs of the multiple OISs span the first group and the second group, and an arrangement of the first X OISs is substantially incongruent with the first group.

In one or more twenty-first embodiments, further to any of the seventeenth through twentieth embodiments, the multiple PWB structures each extend to a first surface of a photonic integrated circuit (PIC), the first surface extends substantially in a horizontal plane, and the multiple OISs comprise a first plurality of OISs which are each located vertically below the horizontal plane, and a second plurality of OISs which are each located vertically above the horizontal plane.

In one or more twenty-second embodiments, further to any of the seventeenth through twenty-first embodiments, the communication device comprises the multi-core fibers.

In one or more twenty-third embodiments, further to any of the seventeenth through twenty-second embodiments, the communication device is a connector to be coupled to another device which comprises the multi-core fibers.

In one or more twenty-fourth embodiments, further to any of the seventeenth through twenty-third embodiments, the multiple OISs comprise micro-lenses.

In one or more twenty-fifth embodiments, further to any of the seventeenth through twenty-fourth embodiments, printing the multiple PWB structures comprise printing a first PWB structure comprising a first taper portion and a first curved portion which extends from the first taper portion, and printing a second PWB structure comprising a second taper portion and a second curved portion which extends from the second taper portion, and wherein a first total number of local extrema points of the first curved portion is different than a second total number of local extrema points of the second curved portion.

In one or more twenty-sixth embodiments, further to any of the seventeenth through twenty-fifth embodiments, printing the multiple PWB structures comprises printing a first PWB structure comprising a first taper portion and a first curved portion which extends from the first taper portion, and the first curved portion comprises a first section which is concave in a first vertical direction, and a second section which is concave in a second vertical direction which is opposite the first vertical direction.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that practice of the disclosed techniques and architectures is not limited to the embodiments so described but can be modified and altered without departing from the scope of the appended claims. For example, the above embodiments may include specific combinations of features as further provided below.

What is claimed is:

1. A device, comprising:
a communication device comprising multiple optical interface surfaces (OISs) which each correspond to a respective multi-core fiber of a two-dimensional (2D) array of multi-core fibers;
a photonic integrated circuit (PIC) comprising a substrate and multiple waveguide structures in or on the substrate; and
multiple photonic wire bond (PWB) structures each optically coupled between a respective one of the multiple OISs, and a respective one of the waveguide structures.

2. The device of claim 1, wherein:
the multiple waveguide structures comprise a first waveguide structure; and
the multiple PWB structures comprise a first PWB structure which extends over a top surface of the first waveguide structure.

3. The device of claim 1, wherein:
the multiple OISs are arranged in an M×N array of groups which each consist of a respective X OISs;
M, N and X are respective integers each greater than one;
the groups comprise a first group and a second group which is substantially congruent with the first group;
a first X OISs of the multiple OISs span the first group and the second group; and
an arrangement of the first X OISs is substantially incongruent with the first group.

4. The device of claim 1, wherein:
the multiple PWB structures each extend to a first surface of the PIC;
the first surface extends substantially in a horizontal plane; and
the multiple OISs comprise:
a first plurality of OISs which are each located vertically below the horizontal plane; and
a second plurality of OISs which are each located vertically above the horizontal plane.

5. The device of claim 1, wherein the communication device comprises the multi-core fibers.

6. The device of claim 1, wherein the communication device is a connector to be coupled to another device which comprises the multi-core fibers.

7. The device of claim 1, wherein the multiple OISs comprise micro-lenses.

8. The device of claim 1, wherein the multiple PWB structures comprise:
a first PWB structure comprising a first taper portion and a first curved portion which extends from the first taper portion; and
a second PWB structure comprising a second taper portion and a second curved portion which extends from the second taper portion; and
wherein a first total number of local extrema points of the first curved portion is different than a second total number of local extrema points of the second curved portion.

9. The device of claim 1, wherein:
the multiple PWB structures comprise a first PWB structure comprising a first taper portion and a first curved portion which extends from the first taper portion; and
the first curved portion comprises a first section which is concave in a first vertical direction, and a second section which is concave in a second vertical direction which is opposite the first vertical direction.

10. A system, comprising:
a photonic integrated circuit (PIC) comprising a substrate and multiple waveguide structures in or on the substrate;
a plurality of multi-core fibers which form multiple optical interface surfaces (OISs); and
multiple photonic wire bond (PWB) structures each optically coupled between a respective one of the multiple OISs and a respective one of the waveguide structures; wherein:
the multiple OISs are arranged in an M×N array of groups which each consist of a respective X OISs;
M, N and X are respective integers each greater than one;
the groups comprise a first group and a second group which is substantially congruent with the first group;
a first X OISs of the multiple OISs span the first group and the second group; and
an arrangement of the first X OISs is substantially incongruent with the first group.

11. The system of claim 10, wherein:
the multiple waveguide structures comprise a first waveguide structure; and
the multiple PWB structures comprise a first PWB structure which extends over a top surface of the first waveguide structure.

12. The system of claim 10, wherein:
the multiple PWB structures each extend to a first surface of the PIC;
the first surface extends substantially in a horizontal plane; and
the multiple OISs comprise:
a first plurality of OISs which are each located vertically below the horizontal plane; and
a second plurality of OISs which are each located vertically above the horizontal plane.

13. The system of claim 10, further comprising a connector which is coupled between the multi-core fibers and the multiple PWB structures.

14. The system of claim 10, wherein the multiple PWB structures comprise:
a first PWB structure comprising a first taper portion and a first curved portion which extends from the first taper portion; and
a second PWB structure comprising a second taper portion and a second curved portion which extends from the second taper portion; and
wherein a first total number of local extrema points of the first curved portion is different than a second total number of local extrema points of the second curved portion.

15. The system of claim 10, wherein:
the multiple PWB structures comprise a first PWB structure comprising a first taper portion and a first curved portion which extends from the first taper portion; and
the first curved portion comprises a first section which is concave in a first vertical direction, and a second section which is concave in a second vertical direction which is opposite the first vertical direction.

16. A method comprising:
attaching a communication device to a substrate, the communication device comprising multiple optical interface surfaces (OISs) which each correspond to a respective multi-core fiber of a two-dimensional (2D) array of multi-core fibers, wherein multiple waveguide structures are in or on the substrate;
attaching two or more optical devices to the substrate; and
printing multiple photonic wire bond (PWB) structures which each extend between a respective one of the multiple OISs, and a respective one of the waveguide structures.

17. The method of claim 16, wherein the multiple PWB structures are printed with a two-photon polymerization process.

18. The method of claim 16, wherein:
the multiple OISs are arranged in an M×N array of groups which each consist of a respective X OISs;
M, N and X are respective integers each greater than one;
the groups comprise a first group and a second group which is substantially congruent with the first group;
a first X OISs of the multiple OISs span the first group and the second group; and
an arrangement of the first X OISs is substantially incongruent with the first group.

19. The method of claim 16, wherein:
the multiple PWB structures each extend to a first surface of a photonic integrated circuit (PIC);
the first surface extends substantially in a horizontal plane; and
the multiple OISs comprise:
a first plurality of OISs which are each located vertically below the horizontal plane; and
a second plurality of OISs which are each located vertically above the horizontal plane.

20. The method of claim 16, wherein:
printing the multiple PWB structures comprises printing a first PWB structure comprising a first taper portion and a first curved portion which extends from the first taper portion; and
the first curved portion comprises a first section which is concave in a first vertical direction, and a second section which is concave in a second vertical direction which is opposite the first vertical direction.
